(19) United States
(12) Patent Application Publication
(10) Pub. No.: US 2025/0010736 A1
(43) Pub. Date: Jan. 9, 2025

(54) ELECTRIC VEHICLE CHARGING TERMINAL INCLUDING MULTIPLE SOCKETS OF DIFFERENT STANDARDS

(71) Applicant: Young Suk CHOI, Seoul (KR)

(72) Inventor: Young Suk CHOI, Seoul (KR)

(21) Appl. No.: 18/764,842

(22) Filed: Jul. 5, 2024

(30) Foreign Application Priority Data
Jul. 5, 2023 (KR) 10-2023-0086860

(51) Int. Cl. B60L 53/16; H01R 13/447; H02J 7/00

(52) U.S. Cl. CPC B60L 53/16; H01R 13/447; H02J 7/0042; H01R 2201/26

(57) ABSTRACT

An electric vehicle charging terminal includes: a first socket; a second socket disposed at upper and lower or left and right of the first socket, and having a different standard from the first socket; an outer cover blocking the first socket and the second socket from the outside and opened and closed; and a sliding door disposed between the outer cover and the first socket or the second socket, and configured to move up and down or left and right to expose only one of the first socket or the second socket and block the other socket, in which the sliding door is configured to select a socket to be exposed among the first socket or the second socket by up and down or left and right movement. As a result, the electric vehicle charging terminal May use the chargers of different standards to block unused sockets during charging to improve the safety.

### CROSS-REFERENCE TO RELATED APPLICATIONS

This application claims the priority of Korean Patent Application No. 10-2023-0086860 filed on Jul. 5, 2023, in the Korean Intellectual Property Office, the disclosure of which is incorporated herein by reference.

### BACKGROUND

The present disclosure relates to an electric vehicle charging terminal that includes a plurality of charging sockets so that all chargers of different standards can be used when charging an electric vehicle battery, and selects one of the charging sockets for charging.

Electric vehicles are vehicles that obtain their driving energy from electrical energy rather than obtaining from combustion of fossil fuels like existing internal combustion engine vehicles. The electric vehicles have many advantages, including no exhaust gases, very low noise, low maintenance costs compared to existing internal combustion engine vehicles, and improvement in environmental issues due to the reduction of carbon dioxide.

In order to operate these electric vehicles, it is essential to charge the battery to drive the motor, and charging stations equipped with one or more chargers are being installed in various places such as apartment complexes, large supermarkets, parking lots of public institutions, as well as highway rest areas. When a charger plug is connected to the charging terminal exposed to the outside, the electric vehicle battery is charged by receiving AC or DC power from the charger. The charging terminal and the charger plug of the electric vehicle should be of the same standard to enable electrical connection and charge the battery. Depending on the type of standard, the charger plug and charging terminal include ports, pins, or connectors that may receive DC power, ports, pins, or connectors that may receive AC power, or ports, pins, or connectors that may receive both the DC and AC power.

For example, referring to FIG. 1A, a socket 11 to which the Combined Charging System (CCS) type 1 standard, which is widely used in Korea and North America, is applied, is composed of a combo type including five pins (or connector) for slow charging at the top and two pins (or connector) for fast charging at the bottom. Among the five pins at the top, the top two are pins or connectors for supplying AC power, and the bottom two are pins or connectors for communication including a ground wire. The two pins at the bottom are pins or connectors for supplying DC power.

In addition, referring to FIG. 1B, a socket 13 to which the North American Charging Standard (NACS) type standard used in several countries, including North America, is applied, is composed of a total of five pins or connectors. The top two pins are pins or connectors for selectively supplying DC or AC power, and the bottom three pins are pins or connectors for communication.

In addition to the CCS type 1 and NACS standards described above, there are various standards such as CCS type 2 used mainly in Europe or CHAdeMO used mainly in Japan. Charging standards are divided depending on the electric vehicle production brand, and due to the existence of these various standards, chargers of different standards are being installed even within one country. Some brands may provide a separate charger adapter so that a charger of another standard may be used. However, the size of the charger adapter is large and inconvenient to carry, female users complain of discomfort with the charger adapter because the connection to the charging plug is not smooth, and there is a risk of vehicle breakdown, fire or explosion when the charger adapter is used beyond the allowable voltage and output.

Meanwhile, there is a lot of discussion about setting a global standard in one way, but it is difficult to achieve agreement due to differences in the market share situation of each brand, charger infrastructure already installed in each country, etc. In this situation, there is an urgent need for a method for enabling charging in response to chargers of various standards from an electric vehicle itself without any unsafe and inconvenient separate components such as an adapter.

### SUMMARY

An object of the present disclosure is to provide a charging terminal that enables connection of a charger plug by exposing only one of different charging sockets that meets a standard of the charger through a sliding door that can be slid, in the charging terminal of an electric vehicle that includes charging sockets of different standards.

Problems to be solved by the present disclosure are not limited to the above-described problem(s). Other problem(s) that is not described may be obviously understood by those skilled in the art from the following description.

In order to achieve one object of the present disclosure, according to an aspect of the present disclosure, an electric vehicle charging terminal includes: a first socket; a second socket disposed at upper and lower or left and right of the first socket, and having a different standard from the first socket; an outer cover blocking the first socket and the second socket from the outside and opened and closed; and a sliding door disposed between the outer cover and the first socket or the second socket, and configured to move up and down or left and right to expose only any one of the first socket or the second socket and block the other socket, in which the sliding door may be configured to select a socket to be exposed among the first socket or the second socket by up and down or left and right movement.

The electric vehicle charging terminal may further include a control unit controlling the movement of the sliding door, in which the sliding door may operate according to user's settings through the control unit to expose one of the first socket or the second socket.

The electric vehicle charging terminal may further include a control unit generating exposed socket information on which of the first socket or the second socket is exposed by the movement of the sliding door.

The charging terminal may set a maximum charging voltage to a preset value from the exposed socket information.

When the exposed socket information is a Combined Charging System (CCS), a preset value may be 800 V, and when the exposed socket information is a North American Charging Standard (NACS), the preset value may be 500 V.

The sliding door may block some of a plurality of pins or connectors included in the first socket or the second socket.

According to an exemplary embodiment of the present disclosure, the charging terminal of the electric vehicle including multiple sockets of different standards may enable charging by operating a sliding door to expose one socket that meets the standard of the charger to be charged to provide the convenience of use so that chargers of different standards can be used, and at the same time, block other types of sockets to increase safety.

### BRIEF DESCRIPTION OF THE DRAWINGS

The above and other aspects, features and other advantages of the present disclosure will be more clearly understood from the following detailed description taken in conjunction with the accompanying drawings, in which:

FIGS. 1A and 1B are diagrams schematically illustrating electric vehicle charging terminals of different standards; and

FIGS. 2A to 6B are diagrams schematically illustrating a sliding door included in a charging terminal according to exemplary embodiments of the present disclosure.

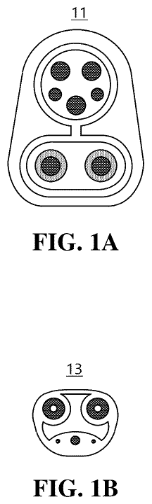

### DETAILED DESCRIPTION OF THE EMBODIMENT

Advantages and features of the present disclosure and methods accomplishing them will become apparent from the following description of exemplary embodiments with reference to the accompanying drawings. However, the present disclosure is not limited to exemplary embodiments disclosed below, and may be implemented in various different forms, these exemplary embodiments will be provided only in order to make the present disclosure complete and allow one of ordinary skill in the art to which the present disclosure pertains to completely recognize the scope of the present disclosure, and the present disclosure will be defined by the scope of the claims. Throughout the specification, like reference numerals denote like elements.

Hereinafter, exemplary embodiments of the present disclosure will be described in detail with reference to the accompanying drawings.

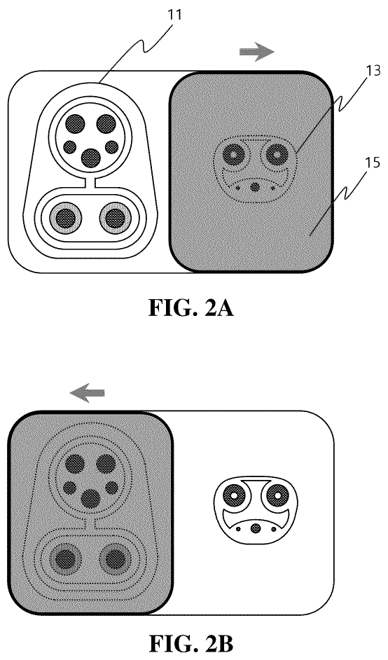

FIGS. 2 to 6 are diagrams schematically illustrating a sliding door 15 included in a charging terminal according to exemplary embodiments of the present disclosure.

The electric vehicle charging terminal according to an exemplary embodiment of the present disclosure includes a first socket 11, a second socket 13, a sliding door 15, and an outer cover (not illustrated) that covers all of the first socket 11, the second socket 13, the sliding door 15 to be blocked from the outside. When the outer cover is opened, the sliding door 15 and one of the first socket 11 or the second socket 13 that are not covered by the sliding door are revealed. The sliding door 15 is disposed between the outer cover and the sockets. The sliding door 15 may be formed in the same shape as a sliding door and may move up and down or left and right directions. A user may select the first socket 11 or the second socket 13 so that only one of the first socket 11 or the second socket 13 is exposed by moving the sliding door 15 up and down or left and right directions. When one of the first socket 11 or the second socket 13 is exposed, the other socket is automatically blocked by the sliding door 15. Therefore, the user may proceed with charging by moving the sliding door 15 so that the socket that meets the standard of the charger is opened, or exposed, and at the same time, the socket that does not meet the standard of the charger may be blocked for safety. By applying a physical switch or a switching circuit to the sliding door 15, the exposed socket terminal may be configured to be connected to the battery, and the blocked socket terminal may be configured to be disconnected from the battery.

For one of the first socket 11 or the second socket 13, different standards are applied to the first socket 11 and the second socket 13. FIGS. 2 to 6 illustrate that the first socket 11 is CCS type 1 and the second socket 13 is NACS type, but it is not limited to thereto, and various standards such as CCS type 2, CHAdeMO, or GB/T may also be applied. The arrangement shape of the first socket 11 and the second socket 13 may be arranged in various ways in consideration of the exposed portion of the charging terminal in the vehicle, design, convenience of charging, or safety. For example, the first socket 11 and the second socket 13 may be horizontally arranged side by side or vertically aligned.

The charging terminal according to an exemplary embodiment of the present disclosure may further include a control unit (not illustrated) that controls the movement of the sliding door. The outer cover may be opened and the sliding door may move manually, but the sliding door may automatically move through the control unit including an interface such as an infotainment system or a physical selection switch of the vehicle. In other words, when a socket that is to be exposed, that is, to which the charging plug is to be connected is selected through the control unit, the sliding door may automatically move by the motor driving, etc., to expose the corresponding socket.

The charging terminal according to an exemplary embodiment of the present disclosure may further include the control unit that generates exposed socket information on which of the first socket or the second socket is exposed by the movement of the sliding door. When the user manually moves the sliding door to expose one socket, the control unit generates the corresponding socket information exposed, that is, the exposed socket information.

The charging terminal may set a maximum allowable charging voltage through the exposed socket information. When a voltage exceeding the maximum charging voltage is applied from the charger, the charging terminal may block the flow of current to protect the battery or the charging circuit. This is because the maximum voltage recommended or enforced by manufacturers, etc. is different for each standard, and when a voltage exceeding the actual maximum voltage is applied, many problems such as the vehicle becoming inoperable occur. For example, in the case of the NACS standard, some manufacturers recommend charging under power of 300 V or lower, and vehicle breakdown may occur frequently when connected to a charger that exceeds the voltage.

When using chargers of different standards using an adapter, it is necessary to set the maximum charging voltage to prevent bigger problems such as a fire. Actually, an adapter (CCS1 to NACS) is often used to charge the charging terminal of the NACS standard, which is allowed up to 500 V, with a CCS type 1 charger. In the case of the fast CCS type 1 charger, since high voltage power of 800 V or higher is sometimes applied, without taking into account the manufacturer's instructions, a fire may occur due to the vehicle breakdown or the overheating of the adapter. Therefore, many of the above problems may be solved by setting the maximum charging voltage and determining whether to turn off the power using the exposed socket information of the charging terminal. In an exemplary embodiment of the present disclosure, the charging terminal may set the maximum charging voltage to a preset value from the exposed socket information. For example, the preset value may be 800 V when the exposed socket information is the CCS type 1, and may be 500 V if the exposed socket information is NACS.

According to an exemplary embodiment of the present disclosure, the first socket and the second socket may be arranged in various ways, and accordingly, the shape of the sliding door may also be formed in various ways.

Referring to FIG. 2A, the first socket 11 may be exposed by moving the sliding door 15 to the right, and at the same time, the second socket 13 may be set to be covered and blocked. In addition, as illustrated in FIG. 2B, in the case of using the charger that meets the standard of the second socket, the sliding door 15 may be pushed to the left to expose the second socket 13, thereby performing the charging.

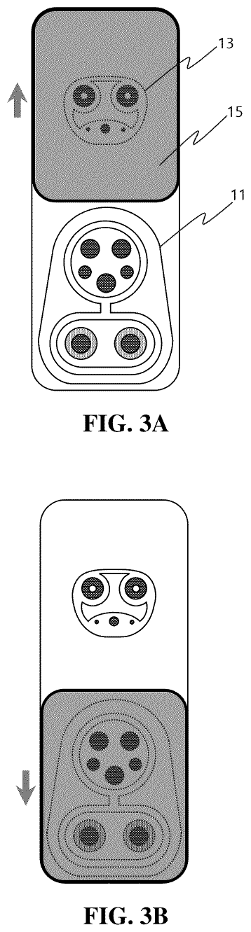

Referring to FIG. 3, the first socket 11 and the second socket 13 are arranged up and down, and the socket of the standard meeting the charger may be selected by pushing or dragging the sliding door 15 in up and down directions. The first socket 11 is illustrated to be disposed at the bottom, but is not limited thereto, and the charging terminal may be formed so that the first socket is disposed above the second socket.

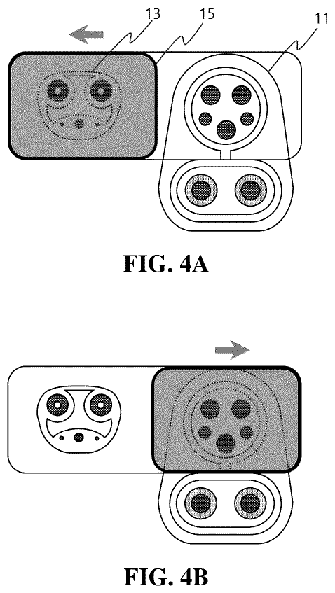

FIGS. 4 to 6 are diagrams illustrating examples in which the sliding door 15 is set to block some of a plurality of pins or connectors included in the first socket 11 or the second socket 13, according to an exemplary embodiment of the present disclosure. By considering the sizes of various standard sockets, the arrangement of pins or connectors, and design elements, etc., an area, a moving range, etc., of the sliding door may be formed. Even if the sliding door covers only some of the pins or connectors of the socket to be blocked, the connection of the charger plug to the socket is inevitable and the exposed socket can be charged by connecting the charger plug, making it possible to achieve the purpose of the present disclosure.

Referring to FIG. 4A, the second socket 13 is disposed on the left side of the first socket 11, and the sliding door 15 is set to move to the left to expose the first socket 11 and to cover the entire second socket 13. Referring to FIG. 4B, when the sliding door 15 moves to the right so that the second socket 13 is exposed, the sliding door 15 may be formed to cover only the top five pins or connectors of the first socket 11.

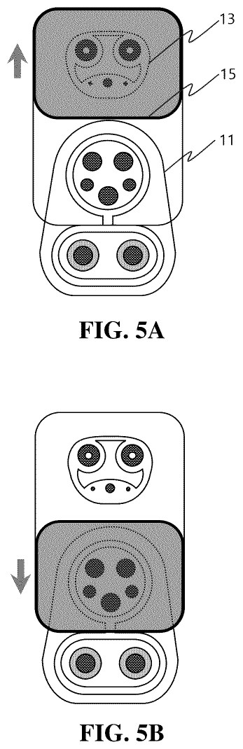

Referring to FIG. 5A, the second socket 13 is disposed above the first socket 11, and the sliding door 15 is set to move the sliding door 15 upward so that the first socket 11 is exposed and to cover the entire second socket 13. Referring to FIG. 5B, when the sliding door 15 moves the sliding door 15 downward so that the second socket 13 is exposed, the sliding door 15 may be formed to cover only the top five pins or connectors of the first socket 11.

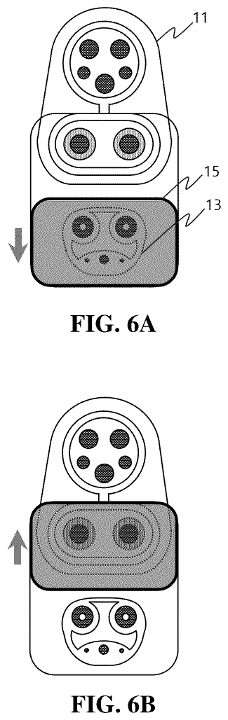

Referring to FIG. 6A, the second socket 13 is disposed below the first socket 11, and the sliding door 15 is set to move the sliding door 15 downward so that the first socket 11 is exposed and to cover the entire second socket 13. Referring to FIG. 6B, when the sliding door 15 moves upward so that the second socket 13 is exposed, the sliding door 15 may be formed to cover only the bottom two pins or connectors of the first socket 11.

FIGS. 4 to 6 illustrate the form that the sliding door is arranged to cover some of the pins or connectors of the second socket, but is not limited thereto, and may be set to cover some of the first sockets or connectors. In addition, the shape, size, and arrangement of the sliding door may vary so that only one of the first socket and the second socket may be exposed and the other may block the connection of the charger.

Hereinabove, although specific exemplary embodiments of the present disclosure have been described, various modifications may be made without departing from the scope of the present disclosure. Therefore, the scope of the present disclosure should be not construed as being limited to the described exemplary embodiments but be defined by the appended claims as well as equivalents thereto.

Although the present disclosure has been described with reference to the exemplary embodiments and the accompanying drawings, it is not limited to the above-mentioned exemplary embodiments but may be variously modified and changed from the above description by those skilled in the art to which the present disclosure pertains. Therefore, the scope and spirit of the present disclosure should be understood only by the following claims, and all of the equivalences and equivalent modifications to the claims are intended to fall within the scope and spirit of the present disclosure.

What is claimed is:

1. An electric vehicle charging terminal, comprising:
a first socket;
a second socket disposed at upper and lower or left and right of the first socket, and having a different standard from the first socket;
an outer cover blocking the first socket and the second socket from an outside and opened and closed; and
a sliding door disposed between the outer cover and the first socket or the second socket, and configured to move up and down or left and right to expose only one of the first socket or the second socket and block the other socket,
wherein the sliding door is configured to select a socket to be exposed among the first socket or the second socket by up and down or left and right movement.

2. The electric vehicle charging terminal according to claim 1, further comprising:
a control unit controlling the movement of the sliding door,
wherein the sliding door operates according to user's settings through the control unit to expose one of the first socket or the second socket.

3. The electric vehicle charging terminal according to claim 1, further comprising:
a control unit generating exposed socket information on which of the first socket or the second socket is exposed by the movement of the sliding door.

4. The electric vehicle charging terminal according to claim 3, wherein the charging terminal sets a maximum charging voltage to a preset value from the exposed socket information.

5. The electric vehicle charging terminal according to claim 4, wherein when the exposed socket information is a Combined Charging System (CCS), the preset value is 800 V, and when the exposed socket information is a North American Charging Standard (NACS), the preset value is 500 V.

6. The electric vehicle charging terminal according to claim 1, wherein the sliding door blocks some of a plurality of pins or connectors included in the first socket or the second socket.
